(19) United States
(12) Patent Application Publication
(10) Pub. No.: US 2019/0028955 A1
(43) Pub. Date: Jan. 24, 2019

(54) COMMUNICATION CONTROL DEVICE

(71) Applicant: MITSUBISHI ELECTRIC CORPORATION, Tokyo (JP)

(72) Inventor: Mari OCHIAI, Tokyo (JP)

(73) Assignee: Mitsubishi Electric Corporation, Tokyo (JP)

(21) Appl. No.: 16/071,877

(22) PCT Filed: Apr. 8, 2016
(86) PCT No.: PCT/JP2016/061600

§ 371 Date: Jul. 20, 2018

(51) Int. Cl. H04W 48/04; H04W 4/44; H04W 72/08; H04W 4/80; H04W 64/00; H04W 72/04; H04B 17/309

(52) U.S. Cl. CPC H04W 48/04; H04W 4/44; H04W 72/082; H04W 4/46; H04W 64/00; H04W 72/0453; H04B 17/309; H04W 4/80

(57) ABSTRACT

A communication control device in a vehicle having a first wireless communication device that performs vehicle-to-infrastructure communication in a predetermined place on a road and a second wireless communication device that performs communication using a frequency band that has a possibility to cause interference with communication of the first wireless communication device, which are mounted in the vehicle, controls the second wireless communication device. The device includes a vehicle-to-infrastructure communication detection unit that detects a communication state of the first wireless communication device, and a radio transmission control unit that controls a transmission operation of the second wireless communication device based on a result of the detection of the vehicle-to-infrastructure communication detection unit.

### FIELD

The present invention relates to a communication control device intended to control communication operations of a wireless communication device equipped in a vehicle.

### BACKGROUND

Recent vehicles have come to be equipped with various wireless communication devices. A representative one is a vehicle-mounted device of the Electronic Toll Collection (ETC) system. Also, a wireless communication device for executing vehicle-to-vehicle communication, vehicle-to-infrastructure communication, and pedestrian-to-vehicle communication to transmit and receive driving support information and the like is mounted in a vehicle. As the number of wireless communication devices mounted in a vehicle increases, the number of cases where two or more wireless communication devices simultaneously perform communication increases.

Further, depending on future frequency allocation, there is a possibility that one and the same frequency band may be used for two or more applications. When the same frequency band is simultaneously used by two or more wireless communications, interference may occur between different wireless communication systems in a vehicle. In particular, when two or more systems use frequency channels close to each other, the transmission of one system may affect the reception of another system.

Specifically, in a state where a communication channel used for vehicle-to-vehicle communication is close to a communication channel used by the ETC system, when the vehicle passes through an ETC gate while transmitting and receiving the driving support information by the vehicle-to-vehicle communication, if the transmission of the vehicle-to-vehicle communication and the reception of the ETC are performed at the same time in one and the same vehicle, a problem may be caused in that the vehicle-mounted device of the ETC system cannot detect a radio wave to be received due to diffracted waves of the transmission of the vehicle-to-vehicle communication or the like.

Therefore, when ETC communication is required at an ETC gate, it is necessary to prevent the ETC communication from being affected, by measures such as suspending the transmission of vehicle-to-vehicle communication. An invention for solving this problem is described in Patent Literature 1.

In the invention described in Patent Literature 1, when a communication device installed in a vehicle enters a predetermined radio wave transmission restriction area, it performs change of a channel to be used, reduction of transmission power, suspension of transmission, or the like so as to avoid interfering with other communications.

### CITATION LIST

### Patent Literature

Patent Literature 1: Japanese Patent Application Laid-open No. 2015-177370

### SUMMARY

### Technical Problem

In the invention described in Patent Literature 1, communication is restricted while the vehicle is present in a predetermined radio wave transmission restriction area. Therefore, there has been a possibility of restricting communication more than necessary. In a system that transmits and receives necessary information in a predetermined area, such as the ETC system, the time during which communication is actually performed is considered to be very shorter than the time during which the wireless communication device is present in the area. As described above, there is a problem that even in a period of time during which there is no possibility of interfering with other communications and communication to be done has no problem, the communication is restricted, then leading to a longer time during which important information such as driving support information cannot be transmitted and received.

The present invention has been made in view of the above circumstances, and an object thereof is to provide a communication control device capable of preventing a length of time to perform communication restriction for avoiding interference from becoming longer than necessary.

### Solution to Problem

In order to solve the above problems and achieve the object, the present invention provides a communication control device in a vehicle having a first wireless communication device to perform vehicle-to-infrastructure communication in a predetermined place on a road and a second wireless communication device to perform communication using a frequency band that has a possibility to cause interference with communication of the first wireless communication device, which are equipped in the vehicle, controls the second wireless communication device. The communication control device detects a communication state of the first wireless communication device, and controls a transmission operation of the second wireless communication device based on a result of the detection.

### Advantageous Effects of Invention

The communication control device according to the present invention has an advantageous effect that it is possible to prevent a length of time to perform communication restriction for avoiding interference from becoming longer than necessary.

### BRIEF DESCRIPTION OF DRAWINGS

FIG. 1 is a diagram illustrating a configuration example of an in-vehicle communication apparatus realized by applying a communication control device according to a first embodiment thereto.

FIG. 2 is a diagram illustrating a configuration example of the communication control device according to the first embodiment.

FIG. 3 is a flowchart illustrating an operation example of the communication control device according to the first embodiment.

FIG. 4 is a diagram for explaining an example where interference regarded as a problem in the first embodiment occurs.

FIG. 5 is a diagram illustrating a configuration example of a communication control device according to a second embodiment.

FIG. 6 is a flowchart illustrating an operation example of the communication control device according to the second embodiment.

FIG. 7 is a diagram illustrating a specific example of an operation when the communication control device according to the second embodiment is used for an application.

FIG. 8 is a diagram illustrating a configuration example of a communication control device according to a third embodiment.

FIG. 9 is a flowchart illustrating an operation example of the communication control device according to the third embodiment.

FIG. 10 is a flowchart illustrating an operation example of a second wireless communication device controlled by the communication control device according to the third embodiment.

FIG. 11 is a flowchart illustrating an operation example of a communication control device according to a fourth embodiment.

FIG. 12 is a diagram illustrating a configuration example of a communication control device according to a fifth embodiment.

FIG. 13 is a flowchart illustrating an operation example of a radio reception control unit according to the fifth embodiment.

FIG. 14 is a hardware configuration diagram of the communication control device according to the first to fifth embodiments.

FIG. 15 is a hardware configuration diagram of the communication control device according to the first to fifth embodiments.

### DESCRIPTION OF EMBODIMENTS

Hereinafter, a communication control device according to embodiments of the present invention will be described in detail with reference to the drawings. Note that the invention is not necessarily limited by these embodiments.

### First Embodiment

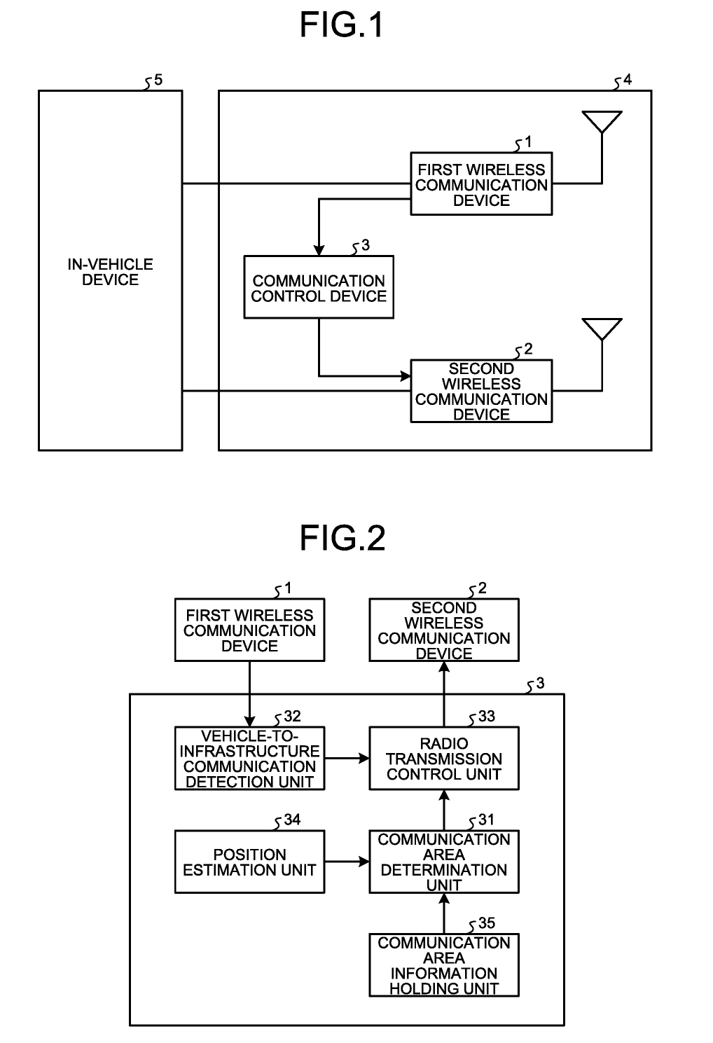

FIG. 1 is a diagram illustrating a configuration example of an in-vehicle communication apparatus realized by applying a communication control device according to the first embodiment of the present invention to the apparatus. An in-vehicle communication apparatus 4 according to the first embodiment is mounted in a vehicle such as an automobile together with an in-vehicle device 5, and performs vehicle-to-infrastructure communication and vehicle-to-vehicle communication. The in-vehicle communication apparatus 4 transmits data to and receives data from the in-vehicle device 5. The in-vehicle device 5 is mounted in the vehicle, and serves as one of various kinds of devices that perform communication with the outside via the in-vehicle communication apparatus 4. The in-vehicle device 5 corresponds to a constituent device of the ETC system, a constituent device of a car navigation system, a constituent device of an audio system, a constituent device of a driving support system, and/or the like. In practice, two or more in-vehicle devices are connected to the in-vehicle communication apparatus 4, but in FIG. 1, two or more in-vehicle devices are collectively described as the in-vehicle device 5.

The in-vehicle communication apparatus 4 includes a first wireless communication device 1, a second wireless communication device 2, and a communication control device 3. These devices may be housed in a single housing or may be housed in different housings.

The first wireless communication device 1 performs vehicle-to-infrastructure communication that is communication with roadside apparatuses installed along roads, at store entrances, and the like. When the first wireless communication device 1 detects or receives a prescribed signal transmitted from a roadside apparatus, the first wireless communication device 1 carries out communication with the roadside apparatus. The communication performed by the first wireless communication device 1 is assumed to have a higher priority than the communication performed by the second wireless communication device 2, and to be required to have higher reliability than the latter.

The second wireless communication device 2 performs vehicle-to-vehicle communication that is communication with a communication device mounted in another vehicle, vehicle-to-infrastructure communication, or pedestrian-to-vehicle communication that is communication with a communication device carried by a pedestrian. A usage frequency band of the second wireless communication device 2 is the same as the first wireless communication device 1, or is a frequency band very close to a usage frequency band of the first wireless communication device 1, and so the communication by the second wireless communication device 2 is assumed to have a possibility to interfere with the communication of the first wireless communication device 1.

The communication control device 3 controls the transmission operation of the second wireless communication device 2 based on the communication state of the first wireless communication device 1.

In the present description, the expression “the position of the vehicle” or the like is sometimes used. This means “the position of the in-vehicle communication apparatus 4,” “the position of the first wireless communication device 1,” “the position of the second wireless communication device 2,” or “the position of the communication control device 3.” That is, “the vehicle” sometimes means “the in-vehicle communication apparatus 4,” “the first wireless communication device 1,” “the second wireless communication device 2,” or “the communication control device 3.”

FIG. 2 is a diagram illustrating a configuration example of the communication control device 3 according to the first embodiment. The communication control device 3 includes a communication area determination unit 31, a vehicle-to-infrastructure communication detection unit 32, a radio transmission control unit 33, a position estimation unit 34, and a communication area information holding unit 35.

The communication area determination unit 31 determines whether or not the position of the vehicle is within an area in which the first wireless communication device 1 performs communication. Specifically, when position information of the vehicle is inputted from the position estimation unit 34, the communication area determination unit 31 determines whether or not the position of the vehicle is within an area in which the first wireless communication device 1 performs communication, based on the inputted position information and area information on areas in which the first wireless communication device 1 performs communication, the area information being held in the communication area information holding unit 35. The communication area determination unit 31 outputs the determination result to the radio transmission control unit 33. For example, the communication area determination unit 31 outputs, to the radio transmission control unit 33, a signal that is at a High level when the position of the vehicle is within an area in which the first wireless communication device 1 performs communication, but is at a Low level when the position of the vehicle is out of the area.

The vehicle-to-infrastructure communication detection unit 32 determines the communication state of the first wireless communication device 1, specifically, determines whether the first wireless communication device 1 is currently communicating or not. The vehicle-to-infrastructure communication detection unit 32 determines the communication state of the first wireless communication device 1, based on a signal outputted from the first wireless communication device 1 for notifying the unit 32 of the communication status. The vehicle-to-infrastructure communication detection unit 32 is a communication state detection unit that detects the communication state of the first wireless communication device 1. A signal for notifying the vehicle-to-infrastructure communication detection unit 32 of the communication status from the first wireless communication device 1 is newly created internally by the first wireless communication device 1, or a used signal having this function selected from among existing signals used internally by the device 1. For example, if there is a signal that changes in status between a communicating state and a non-communicating state, among signals in the first wireless communication device 1, the first wireless communication device 1 outputs that signal. Alternatively, the first wireless communication device 1 generates and outputs signals indicating such states as communication start, completion, during reception, and during transmission. The term “during communication” as used herein refers not only to a period of time of reception or transmission but also to a period of time between the start of communication with a roadside apparatus and the completion of a series of communication sequences. The vehicle-to-infrastructure communication detection unit 32 monitors signals outputted from the first wireless communication device 1 to determine whether or not the first wireless communication device 1 is currently communicating, and outputs information indicating the communication state of the first wireless communication device 1 to the radio transmission control unit 33. For example, the vehicle-to-infrastructure communication detection unit 32 outputs, to the radio transmission control unit 33, a signal that is at a High level when the first wireless communication device 1 is communicating, but is at a Low level when the first wireless communication device 1 is not communicating. The vehicle-to-infrastructure communication detection unit 32 monitors in a predetermined cycle, that is, determines the communication status of the first wireless communication device 1.

The radio transmission control unit 33 controls the transmission operation of the second wireless communication device 2, based on information inputted from the vehicle-to-infrastructure communication detection unit 32 and information inputted from the communication area determination unit 31. Specifically, when information is inputted from the communication area determination unit 31, the radio transmission control unit 33 determines whether or not the vehicle has entered a vehicle-to-infrastructure communication area that is an area in which the first wireless communication device 1 performs communication. When the vehicle has entered the vehicle-to-infrastructure communication area, the radio transmission control unit 33 restricts the transmission operation of the second wireless communication device 2. When the state indicated by information inputted from the communication area determination unit 31 changes from a state indicating outside of a vehicle-to-infrastructure communication area to a state indicating inside of a vehicle-to-infrastructure communication area, the radio transmission control unit 33 determines that the vehicle has entered the vehicle-to-infrastructure communication area. When the radio transmission control unit 33 that has restricted the transmission operation of the second wireless communication device 2 receives input of information from the vehicle-to-infrastructure communication detection unit 32, the radio transmission control unit 33 determines whether communication by the first wireless communication device 1 has been completed or not, based on the inputted information. When the communication has been completed, the radio transmission control unit 33 removes the restriction on the transmission operation of the second wireless communication device 2. For example, in a case where the radio transmission control unit 33 is configured to receive input of a first signal that is at a High level when the first wireless communication device 1 is in communication from the vehicle-to-infrastructure communication detection unit 32, and to receive input of a second signal that is at a High level when the vehicle is in a vehicle-to-infrastructure communication area from the communication area determination unit 31, when the second signal changes from a Low level to a High level, the radio transmission control unit 33 restricts the transmission operation of the second wireless communication device 2, and thereafter, at the point in time when the first signal that has changed from a Low level to a High level further changes to a Low level, the radio transmission control unit 33 removes the restriction on the transmission operation of the second wireless communication device 2. Also when the radio transmission control unit 33 has left the vehicle-to-infrastructure communication area before the completion of the communication of the first wireless communication device 1 after restricting the transmission operation of the second wireless communication device 2, the radio transmission control unit 33 removes the restriction on the transmission operation of the second wireless communication device 2.

The restriction of the transmission operation performed on the second wireless communication device 2 by the radio transmission control unit 33 is any of suspension of transmission, reduction of transmission power, reduction of frequency of transmission, transmission timing control, and switching to a channel that does not affect the reception operation of the first wireless communication device 1. For the transmission timing control, what is specifically designed is control to recognize the reception timing of the first wireless communication device 1 via the vehicle-to-infrastructure communication detection unit 32, and cause the second wireless communication device 2 to allow transmission in an in-between time in which the communication is not affected in the course of the series of communication sequences of the first wireless communication device 1, or the like control. Since the standard met by the communication to be performed by the first wireless communication device 1 is known in advance, the radio transmission control unit 33 can perform the transmission timing control by means of holding or storing information of a communication sequence defined by the standard which the first wireless communication device 1 is compliant with, or the like means. That is, when the radio transmission control unit 33, which has held the information about with what timing communication is to be performed after the first wireless communication device 1 starts communication, is notified that the first wireless communication device 1 has started communication from the vehicle-to-infrastructure communication detection unit 32, the radio transmission control unit 33 can perform the transmission timing control with using this notification as a trigger.

The position estimation unit 34 estimates the current position of the vehicle. The position estimation unit 34 estimates the current position in a predetermined cycle, and outputs position information that is the estimation result thereof to the communication area determination unit 31. The position estimation unit 34 estimates the position of the vehicle using, for example, Global Positioning System (GPS). When a car navigation system is included in the in-vehicle device 5, the communication control device 3 may have a configuration in which the position estimation unit 34 is omitted, and position information of the vehicle is acquired from the car navigation system to input it to the communication area determination unit 31. When an apparatus for performing automatic driving is included in the in-vehicle device 5, and this apparatus requires position information in its automatic driving control, position information obtained for use in the automatic driving control may be used in the communication control device 3. That is, the position information obtained for use in the automatic driving control may be inputted from the in-vehicle device 5 to the communication control device 3 to omit the position estimation unit 34 in the communication control device 3.

The communication area information holding unit 35 holds information on areas in which the first wireless communication device 1 performs communication. The information held by the communication area information holding unit 35 may be any information that can specify areas where the first wireless communication device 1 performs communication. For example, the information held by the communication area information holding unit 35 corresponds to information indicating the installation positions of roadside apparatuses that communicate with the first wireless communication device 1 and standard information, or information indicating the range of arrival of radio waves radiated by the roadside apparatuses that perform communication with the first wireless communication device 1, that is, information indicating areas themselves in which the first wireless communication device 1 performs communication. The standard information is information that can specify a communication area based on combination with the position information of the roadside apparatus, such as the transmission power of the radio waves radiated from the roadside apparatuses. The communication area information holding unit 35 may also hold or store map information. The information held by the communication area information holding unit 35 may be updated at regular intervals or at irregular intervals as appropriate via the first wireless communication device 1 or the second wireless communication device 2. By allowing the information held by the communication area information holding unit 35 to be updated, transmission restriction of the second wireless communication device 2 when the first wireless communication device 1 performs communication can be more reliably performed.

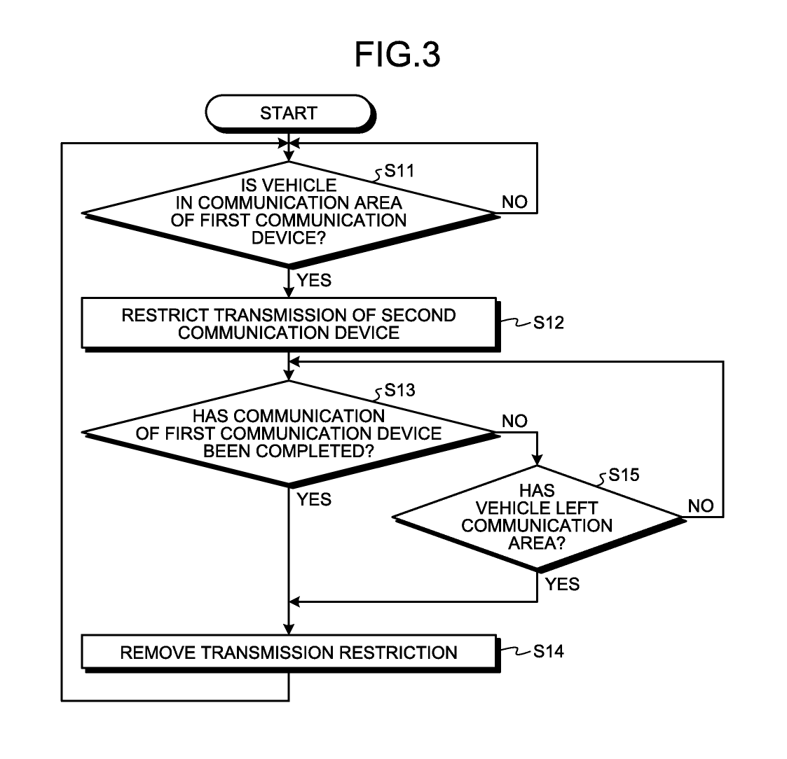

The operation of the communication control device 3 according to the present embodiment will be described in detail with reference to FIG. 3. FIG. 3 is a flowchart illustrating an operation example of the communication control device 3 according to the first embodiment. In the flowchart illustrated in FIG. 3, the first wireless communication device is referred to as a first communication device, and the second wireless communication device is referred to as a second communication device. The same applies to the flowcharts used in the description of second and subsequent embodiments.

The communication control device 3 monitors whether the vehicle is in a communication area of the first wireless communication device 1, that is, a vehicle-to-infrastructure communication area or not. When the vehicle is outside a vehicle-to-infrastructure communication area (step S11: No), the communication control device 3 repeats processing in step S11 and continues the monitoring operation. The determination in step S11 is performed by the communication area determination unit 31. The communication area determination unit 31 compares position information inputted from the position estimation unit 34 with the information held by the communication area information holding unit 35, and determines whether or not the vehicle is in a vehicle-to-infrastructure communication area. Specifically, when the current position of the vehicle indicated by position information inputted from the position estimation unit 34 is in a vehicle-to-infrastructure communication area identified from the information held in the communication area information holding unit 35, the communication area determination unit 31 determines that the vehicle is in the vehicle-to-infrastructure communication area.

When it is determined that the vehicle is in a vehicle-to-infrastructure communication area, more specifically, determined that the vehicle has entered a vehicle-to-infrastructure communication area (step S11: Yes), the communication control device 3 restricts the transmission of the second communication device (step S12). In step S12, the radio transmission control unit 33 instructs the second wireless communication device 2 to restrict the transmission operation. The second wireless communication device 2 having been instructed to restrict the transmission operation switches to a transmission operation predetermined as an operation when a transmission restriction is imposed, such as suspension of the transmission operation, reduction of transmission output, or change of a channel to be used.

After restricting the transmission of the second wireless communication device 2 by executing step S12, the communication control device 3 determines whether communication of the first wireless communication device 1 has been completed (step S13). In step S13, the vehicle-to-infrastructure communication detection unit 32 monitors the communication state of the first wireless communication device 1, and determines whether or not the communication has been finished, that is, whether or not transmission and reception of necessary data with the roadside apparatus have been completed. When the communication has been finished (step S13: Yes), the communication control device 3 removes the transmission restriction on the second wireless communication device 2 (step S14). In step S14, the radio transmission control unit 33 instructs the second wireless communication device 2 to remove the restriction on the transmission operation. After executing step S14, the communication control device 3 returns to step S11 and continues the operation.

When the communication of the first wireless communication device 1 has not been completed (step S13: No), the communication control device 3 determines whether or not the vehicle has left the vehicle-to-infrastructure communication area (step S15). In step S15, the communication area determination unit 31 compares position information inputted from the position estimation unit 34 with the information held in the communication area information holding unit 35, and determines whether the vehicle has left the vehicle-to-infrastructure communication area or not. When the vehicle has not left the vehicle-to-infrastructure communication area (step S15: No), the communication control device 3 returns to step S13 and continues the operation. On the other hand, when the vehicle has left the vehicle-to-infrastructure communication area (step S15: Yes), the communication control device 3 executes step S14 to remove the transmission restriction on the second wireless communication device 2.

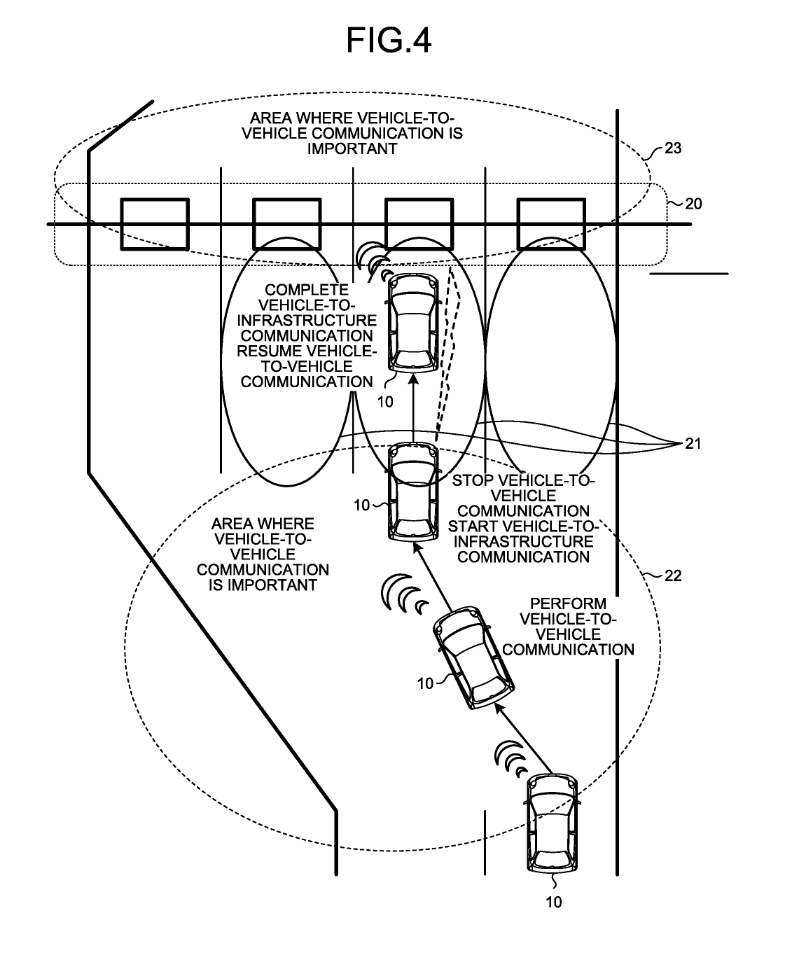

FIG. 4 is a diagram for explaining an example where interference to be a problem in the first embodiment occurs. FIG. 4 illustrates an example where a vehicle 10 approaches an ETC gate 20. In FIG. 4, the vehicle 10 travels in the order of arrows put at the front of the vehicle. Before the ETC gates 20, there are ETC communication areas 21 that are areas in which communication with ETC roadside apparatuses is performed. In addition, there is a branch area 22 before the ETC communication areas 21. There is a merging area 23 ahead of the ETC gates 20. The branch area 22 and the merging area 23 illustrated in FIG. 4 are areas where lanes or the like disappear before and after the ETC gates 20.

The first wireless communication device 1 to be contemplated here is a communication device that performs Dedicated Short Range Communications (DSRC) also called narrowband communication(s). A DSRC communication device performs reception and transmission with tuning in a channel used in transmission of a roadside apparatus, and thus during standby mode, performs reception for all channels of a DSRC communication band so as to be able to receive signals over any channel over which the roadside apparatus transmits the signals.

The vehicle 10 that has run on a main lane selects one ETC gate from where the main lane ends, and travels toward the gate. In the branch area 22 without lanes, vehicle-to-vehicle communication is regarded as important since it is not known which gate vehicles are headed for. That is, in the branch area 22, it is effective for preventing accidents that vehicles exchange information by vehicle-to-vehicle communication and perform driving support. The vehicle 10 also travels while transmitting its vehicle position, vehicle speed, direction, etc. by vehicle-to-vehicle communication.

When the vehicle 10 arrives at the ETC communication area 21, the first wireless communication device 1 starts ETC communication according to a transmission channel of the roadside apparatus. However, in a case where the second wireless communication device 2 carries out transmission in vehicle-to-vehicle communication concurrently with the time of receiving a signal from the roadside apparatus, if the transmission channel of the second wireless communication device 2 is one of reception channels of the first wireless communication device 1, or if a channel close to the reception channel enough for side lobes of transmission waves to give influence, even though the used channels are different between the first and second wireless communication devices, it is difficult for the first wireless communication device 1 to receive the signal from the roadside apparatus.

Therefore, in the communication control device 3 according to the present embodiment, which is mounted in the vehicle 10, when the communication area determination unit 31 detects that the vehicle has entered the ETC communication area 21, the radio transmission control unit 33 instructs the second wireless communication device 2 to suspend the vehicle-to-vehicle communication, thereby preventing the second wireless communication device 2 from interfering with the reception operation of the first wireless communication device 1. Then, when a series of communications necessary for the vehicle to pass through the ETC gate is completed, even if the vehicle 10 is still in the ETC communication area 21, the vehicle-to-infrastructure communication detection unit 32 recognizes the completion of the communication, and the radio transmission control unit 33 instructs the second wireless communication device 2 to resume the vehicle-to-vehicle communication.

In this manner, the vehicle-to-infrastructure communication detection unit 32 recognizes the communication status of the first wireless communication device 1, and upon completion of the communication thereof, the radio transmission control unit 33 causes the second wireless communication device 2 to resume the vehicle-to-vehicle communication. This can minimize the suspension period of the vehicle-to-vehicle communication. As a result, smooth driving control can be realized in the merging area 23 without lanes after the vehicle has passed through the ETC gate 20.

Here has been an example where the radio transmission control unit 33 causes the second wireless communication device 2 to suspend the vehicle-to-vehicle communication. However, as long as interference with the first wireless communication device 1 in the vehicle can be prevented, any one of the above-described transmission restrictions may be used instead of transmission suspension. In addition, although the example of ETC gates using DSRC has been presented, the vehicle-to-infrastructure communication is not limited to ETC gates, and may be a manner of other vehicle-to-infrastructure communication such as an Intelligent Transport Systems (ITS) spot. Furthermore, although the description has been given for an example where the communication in the second wireless communication device is vehicle-to-vehicle communication, the communication in the second wireless communication device may be based on vehicle-to-infrastructure communication and pedestrian-to-vehicle communication using the second wireless communication device 2, a wireless Local Area Network (LAN) used in a vehicle, a communication system of a mobile phone or the like using the same frequency band as the vehicle-to-infrastructure communication or a frequency band close to that of the vehicle-to-infrastructure communication, that is, MuLTEfire, or the like. When it is difficult to perform fine transmission control in a lower layer of the second wireless communication device 2, control in an upper layer can be contemplated so as to eliminate generation of a transmission request.

In the present embodiment, the second wireless communication device 2 constituting the in-vehicle communication apparatus 4 is one system, but may be reconfigured to be two or more systems instead. In a case where the in-vehicle communication apparatus 4 is configured with more than one system of second wireless communication devices 2, the radio transmission control unit 33 restricts the transmission operations of all the second wireless communication devices 2 in areas where the first wireless communication device 1 performs communication.

As described above, upon detecting that the vehicle has entered a vehicle-to-infrastructure communication area that is an area in which the first wireless communication device performs vehicle-to-infrastructure communication that is communication with a higher priority, the communication control device in the present embodiment restricts the transmission operation of the second wireless communication device. When the communication of the first wireless communication device is completed, the communication control device removes the restriction on the transmission operation of the second wireless communication device. This makes it possible to prevent a length of time to perform transmission restriction on the second wireless communication device for avoiding interference between communication by the first wireless communication device and communication by the second wireless communication device, from becoming longer than necessary.

### Second Embodiment

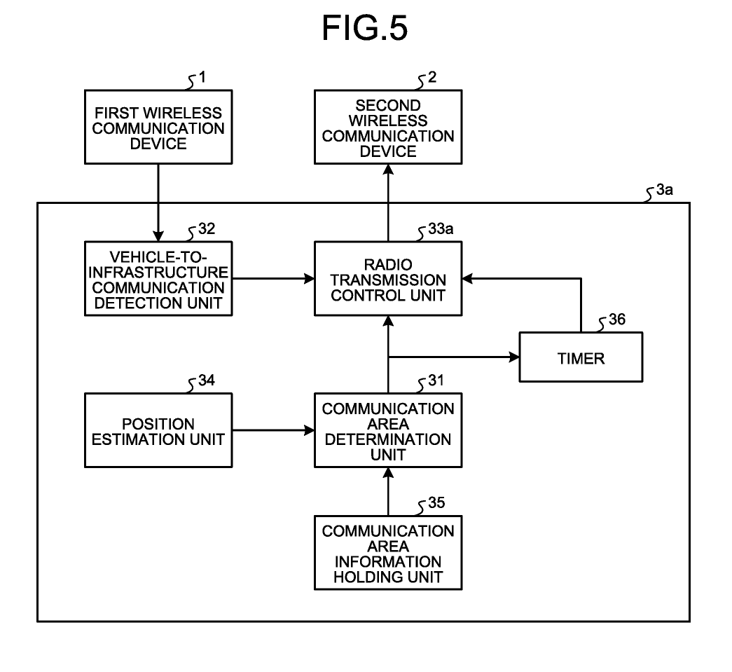

FIG. 5 is a diagram illustrating a configuration example of a communication control device according to the second embodiment. Note that a communication control device 3a according to the second embodiment is equipped in a vehicle together with the in-vehicle device 5 illustrated in FIG. 1, as with the communication control device 3 according to the first embodiment.

The communication control device 3a has a configuration in which the radio transmission control unit 33 of the communication control device 3 according to the first embodiment illustrated in FIG. 2 is replaced by a radio transmission control unit 33a, and further, a timer 36 is added thereto. The other constituent elements of the communication control device 3a are the same as those of the communication control device 3, and thus the same reference symbols are assigned to them and description thereof will be omitted.

In the communication control device 3a, the timer 36 is a counting unit adapted to start counting when a result of determination by the communication area determination unit 31 indicates that the vehicle has entered a vehicle-to-infrastructure communication area, and terminates counting when a predetermined period of time has elapsed since the start of counting. When the timer 36 has terminated its counting, the timer 36 notifies the radio transmission control unit 33a that the predetermined period of time has elapsed.

Based on information inputted from the vehicle-to-infrastructure communication detection unit 32, information inputted from the communication area determination unit 31, and notification from the timer 36, the radio transmission control unit 33a controls the transmission operation of the second wireless communication device 2. Specifically, when information is inputted from the communication area determination unit 31, the radio transmission control unit 33a determines whether or not the vehicle has entered a vehicle-to-infrastructure communication area that is an area in which the first wireless communication device 1 performs communication. When the vehicle has entered the vehicle-to-infrastructure communication area, the radio transmission control unit 33a restricts the transmission operation of the second wireless communication device 2. When the radio transmission control unit 33a that has restricted the transmission operation of the second wireless communication device 2 receives input of information from the vehicle-to-infrastructure communication detection unit 32, the radio transmission control unit 33a determines whether communication by the first wireless communication device 1 has been completed or not, based on the inputted information. When the communication has been completed, the radio transmission control unit 33a removes the restriction on the transmission operation of the second wireless communication device 2. Also, when the predetermined period of time has elapsed without completion of communication of the first wireless communication device 1 since the radio transmission control unit 33a has restricted the transmission operation of the second wireless communication device 2, the radio transmission control unit 33a removes the restriction on the transmission operation of the second wireless communication device 2.

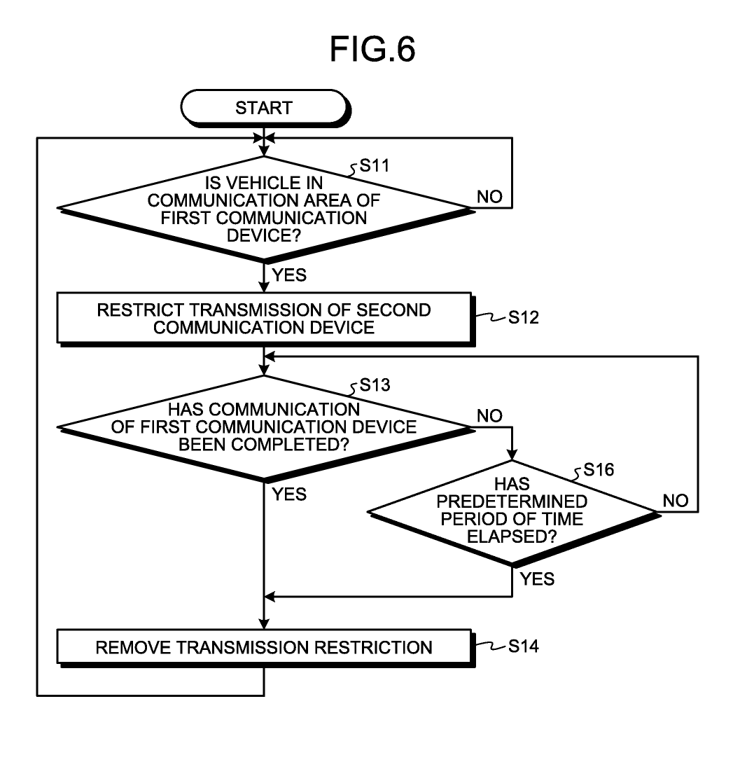

FIG. 6 is a flowchart illustrating an operation example of the communication control device 3a according to the second embodiment. In the flowchart illustrated in FIG. 6, the step S15 in the flowchart illustrated in FIG. 3 corresponding to also the operation of the communication control device 3 according to the first embodiment is replaced by a step S16. Steps other than the step S16 are the same as the steps illustrated in FIG. 6, and thus description thereof will be omitted.

The communication control device 3a restricts the transmission of the second wireless communication device 2 (step S12). When communication of the first wireless communication device 1 has not been completed (step S13: No), the communication control device 3a determines whether or not the predetermined period of time has elapsed since restricting the transmission operation of the second wireless communication device 2, that is, whether or not the predetermined period of time has elapsed since the vehicle has entered the vehicle-to-infrastructure communication area (step S16). In this step S16, the radio transmission control unit 33a monitors the notification from the timer 36, thereby determining whether or not the predetermined period of time has elapsed.

When the predetermined period of time has not elapsed since restriction on the transmission operation of the second wireless communication device 2 (step S16: No), the communication control device 3a returns to the step S13 and continues the operation. On the other hand, when the predetermined period of time has elapsed (step S16: Yes), the communication control device 3a executes a step S14 to remove the transmission restriction on the second wireless communication device 2.

In the communication control device 3a according to the second embodiment, the operation of the timer 36 allows avoidance of unnecessary transmission restriction due to misrecognition of a vehicle-to-infrastructure communication area caused by a problem in the communication area information, that is, the existence of communication area information indicating an area in which communication of the first wireless communication device 1 is not performed, or a large error in estimation of a position of the vehicle, a communication trouble caused by a malfunction in the roadside apparatus, or the like. The predetermined period of time measured by the timer 36 is determined, for example, to be in a range covering a time longer than a required time estimated in a case where the vehicle-to-infrastructure communication is successfully restored after the first wireless communication device 1 has failed the vehicle-to-infrastructure communication several times and a time shorter than the required time until the vehicle leaves a vehicle-to-infrastructure communication area without performing communication in the vehicle-to-infrastructure communication area.

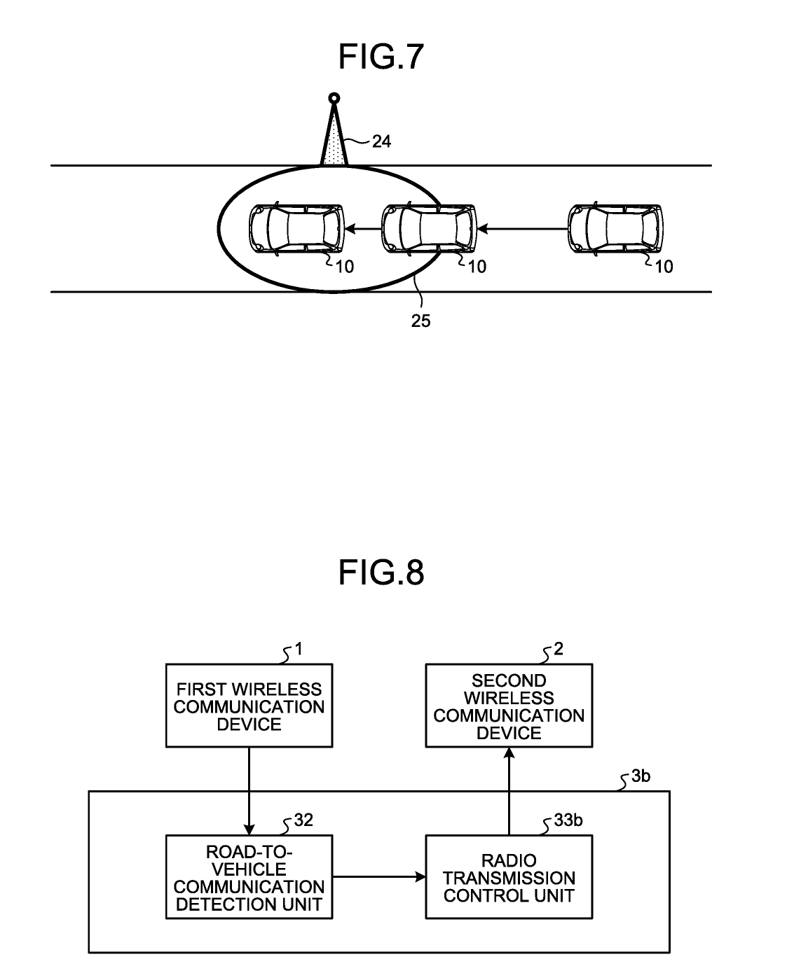

FIG. 7 is a diagram illustrating a specific example of the operation when the communication control device 3a in the second embodiment is applied thereto. FIG. 7 illustrates an example where the vehicle 10 having the first wireless communication device 1, the second wireless communication device 2, and the communication control device 3a illustrated in FIG. 5 equipped therein travels toward a roadside apparatus 24 for an ITS spot. The vehicle 10 travels in the order of arrows put at a front of the vehicle. In the vicinity of the roadside apparatus 24, there is a vehicle-to-infrastructure communication area 25 in which the first wireless communication device 1 performs communication.

The vehicle 10 first travels before the vehicle-to-infrastructure communication area 25, and periodically transmits information using the second wireless communication device 2. In a normal operation, when the vehicle 10 enters the vehicle-to-infrastructure communication area 25, the communication area determination unit 31 detects that the vehicle has entered the vehicle-to-infrastructure communication area 25, based on the position of the vehicle estimated by the position estimation unit 34 and the information held by the communication area information holding unit 35. When the vehicle enters the vehicle-to-infrastructure communication area 25, the radio transmission control unit 33a restricts the transmission of the second wireless communication device 2, and the timer 36 starts measurement of the predetermined fixed period of time. In the vehicle 10 traveling in the vehicle-to-infrastructure communication area 25, when the vehicle-to-infrastructure communication detection unit 32 detects that communication by the first wireless communication device 1 has been completed, the radio transmission control unit 33a is notified of that completion. Upon receiving this notification, the radio transmission control unit 33a removes the transmission restriction on the second wireless communication device 2. On the other hand, in a case where communication by the first wireless communication device 1 has not been started, the radio transmission control unit 33a is notified of the no-start of communication at the time when the predetermined fixed period of time has elapsed based on the timer 36. Upon receiving this notification, the radio transmission control unit 33a removes the transmission restriction on the second wireless communication device 2.

As described above, by virtue of restricting the transmission of the second wireless communication device 2 using the communication status of the first wireless communication device 1, it is possible to resume the communication of the second wireless communication device 2 even if the vehicle 10 is still in the vehicle-to-infrastructure communication area 25 after the completion of the communication of the first wireless communication device 1. Thus, a multitude of wireless communication systems can coexist efficiently. In addition, even when communication in the vehicle-to-infrastructure communication area 25 is not performed, and even when transmission restriction is performed outside the communication area of a roadside apparatus in response to misrecognition, the transmission restriction on the second wireless communication device 2 can be removed at the point in time when the predetermined period of time has elapsed.

Although description herein has been given for the example where the vehicle passes through the ITS spot while performing the vehicle-to-vehicle communication, a communication area of the first wireless communication device 1 may be any communication area covered by a roadside apparatus such as an ETC gate, and is not limited to DSRC. Further, the communication of the second wireless communication device 2 is not limited to the vehicle-to-vehicle communication, and may be any vehicle-to-X (V2X) communication of a communication scheme different from that of the first wireless communication device 1, including a communication system such as a wireless LAN used in the vehicle, or a mobile phone using the same frequency band as the vehicle-to-infrastructure communication or a frequency band close to that of the vehicle-to-infrastructure communication.

As described above, upon detecting that the vehicle has entered a vehicle-to-infrastructure communication area that is an area in which the first wireless communication device performs vehicle-to-infrastructure communication that is communication with a higher priority, the communication control device in the present embodiment restricts the transmission operation of the second wireless communication device. When the communication of the first wireless communication device is completed, the communication control device removes the restriction on the transmission operation of the second wireless communication device. When the predetermined period of time has elapsed with the first wireless communication device not performing communication after restricting the transmission operation of the second wireless communication device, the communication control device removes the restriction on the transmission operation of the second wireless communication device. This makes it possible to prevent a length of time to perform transmission restriction on the second wireless communication device for avoiding interference between the communication performed by the first wireless communication device and the communication performed by the second wireless communication device, from becoming longer than necessary. In addition, even when the communication control device restricts the transmission operation of the second wireless communication device due to misrecognition of a vehicle-to-infrastructure communication area, the communication control device can remove the restriction on the transmission operation of the second wireless communication device.

In the present embodiment, description has been given for the case where the step S16 is executed in place of the step S15 of the flowchart illustrated in FIG. 3, but alternatively, both the steps S15 and S16 may be executed. In this case, for example, when the determination in the step S13 is “No,” the step S15 is executed, and furthermore, when the determination in the step S15 is “No,” that is, when it is determined that the vehicle has not left the communication area, the step S16 is executed. Alternatively, when the determination in the step S13 is “No,” the step S16 is executed, and furthermore, when the determination in the step S16 is “No,” that is, when the predetermined period of time has not elapsed, the step S15 is executed.

### Third Embodiment

FIG. 8 is a diagram illustrating a configuration example of a communication control device according to the third embodiment. Note that a communication control device 3b according to the third embodiment is equipped in a vehicle together with the in-vehicle device 5 illustrated in FIG. 1, as with the communication control device 3 according to the first embodiment.

The communication control device 3b has a configuration in which the radio transmission control unit 33 of the communication control device 3 according to the first embodiment illustrated in FIG. 2 is replaced by a radio transmission control unit 33b, and the communication area determination unit 31, the position estimation unit 34, and the communication area information holding unit 35 are omitted. A vehicle-to-infrastructure communication detection unit 32 of the communication control device 3b is equal to the vehicle-to-infrastructure communication detection unit 32 of the communication control device 3.

The radio transmission control unit 33b controls the transmission operation of the second wireless communication device 2 based on information inputted from the vehicle-to-infrastructure communication detection unit 32. Specifically, when the first wireless communication device 1 starts communication, the radio transmission control unit 33b restricts the transmission operation of the second wireless communication device 2, and when the communication of the first wireless communication device 1 is finished, the radio transmission control unit 33b removes the restriction on the transmission operation of the second wireless communication device 2.

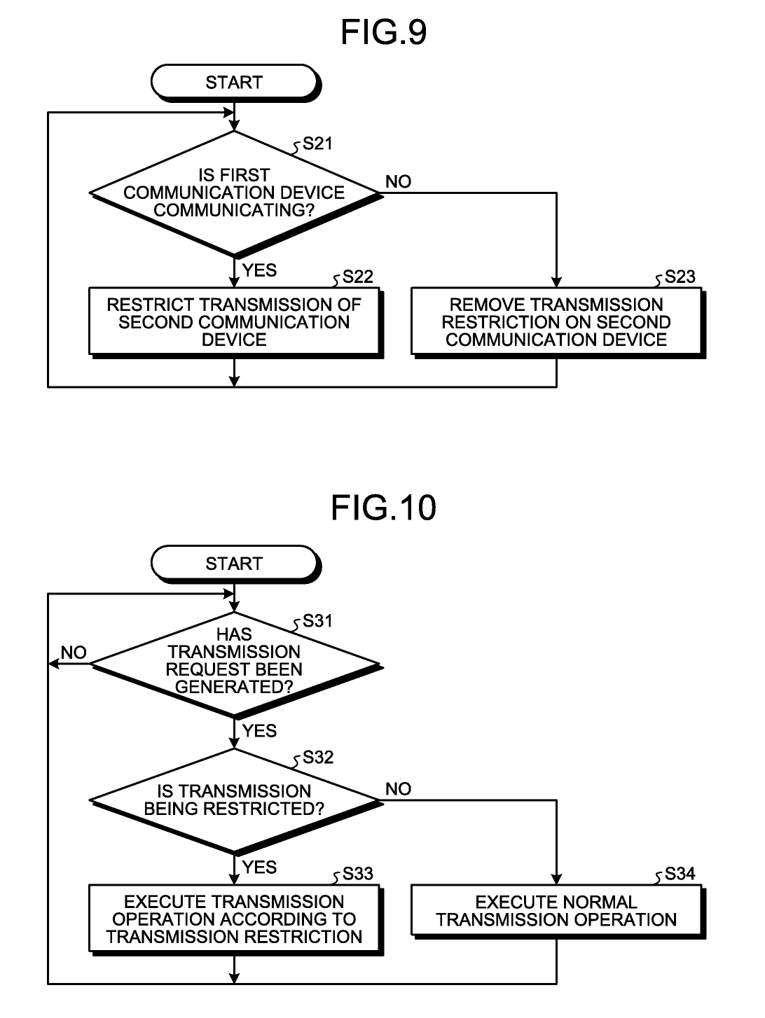

FIG. 9 is a flowchart illustrating an operation example of the communication control device 3b according to the third embodiment. The communication control device 3b monitors whether or not the first wireless communication device 1 is performing communication. When the first wireless communication device 1 is performing communication, that is, when the first wireless communication device 1 starts communication (step S21: Yes), the communication control device 3b restricts the transmission operation of the second wireless communication device 2 (step S22). After executing the step S22, the communication control device 3b returns to the step S21. The processing in the step S22 is a processing similar to the processing in the step S12 of the flowchart illustrating the operation of the communication control device 3 according to the first embodiment, that is, the flowchart illustrated in FIG. 3. When the first wireless communication device 1 is not performing the communication, that is, when the first wireless communication device 1 has finished the communication (step S21: No), the communication control device 3b removes the restriction on the transmission operation of the second wireless communication device 2 (step S23). The processing in the step S23 is similar to the processing of the step S14 in the flowchart illustrating the operation of the communication control device 3 according to the first embodiment, that is, the flowchart illustrated in FIG. 3.

FIG. 10 is a flowchart illustrating an operation example of the second wireless communication device 2 controlled by the communication control device 3b according to the third embodiment. The second wireless communication device 2 according to the third embodiment monitors whether or not a transmission request has occurred in inside thereof (step S31). When no transmission request has occurred (step S31: No), the second wireless communication device 2 repeats the processing of the step S31 and continues the monitoring operation. When a transmission request has occurred (step S31: Yes), the second wireless communication device 2 first determines whether or not the transmission is being restricted (step S32). When the transmission is being restricted (step S32: Yes), the second wireless communication device 2 executes a transmission operation corresponding to the transmission restriction (step S33). The transmission operation corresponding to the transmission restriction means such an operation as suspension of the transmission operation, reduction of transmission output, change of a channel to be used, etc., which are described above. For example, during the transmission restriction, if there is a channel that does not cause interference with the communication of the first wireless communication device 1, the second wireless communication device 2 uses that channel to perform communication. On the other hand, if there is no channel that does not cause interference with the communication of the first wireless communication device 1, as long as transmission of a signal at a low output level that does not cause interference with the communication of the first wireless communication device 1 is allowed, the second wireless communication device 2 performs transmission with transmission output being reduced. In a case where there is no channel that does not cause interference with the communication of the first wireless communication device 1 and transmission of a signal at a low output level that does not cause interference with the communication of the first wireless communication device 1 is not allowed, the second wireless communication device 2 does not perform transmission. When the transmission operation of the second wireless communication device 2 is being restricted, the second wireless communication device 2 may perform its reception operation as usual. When the transmission of the second wireless communication device 2 is not being restricted (step S32: No), the second wireless communication device 2 executes a normal transmission operation, that is, a normal communication operation (step S34). When the operation in the step S33 has been finished, and when the operation in the step S34 has been finished, the second wireless communication device 2 returns to the step S31 and continues the operation.

A specific example where the communication control device 3b is applied will be described with reference to FIG. 7 as in the second embodiment.

The vehicle 10 first travels before the vehicle-to-infrastructure communication area 25, and periodically transmits information using the second wireless communication device 2. When performing communication, the second wireless communication device 2 determines whether or not the first wireless communication device 1 is in communication, that is, whether or not the transmission operation is restricted by the radio transmission control unit 33b. When the second wireless communication device 2 can determine that the first wireless communication device 1 is not in communication, the second wireless communication device 2 performs the normal transmission operation. When the vehicle 10 enters the vehicle-to-infrastructure communication area 25 and the first wireless communication device 1 receives a signal from the roadside apparatus 24, the radio transmission restriction unit 33b receives a signal indicating that the first wireless communication device 1 is in communication, from the vehicle-to-infrastructure communication detection unit 32. In this case, the radio transmission restriction unit 33b restricts the transmission operation of the second wireless communication device 2. By this processing, when the second wireless communication device 2 is ready to have communication, not only carrier sensing of the transmission channel but also carrier sensing of the entire frequency band in which the first wireless communication device 1 can perform communication are realized. Therefore, even when the vehicle-to-infrastructure communication or the like over a different channel is being performed in the first wireless communication device 1, it is possible to detect communication having a possibility of having significant influence, and suppress in-vehicle interference.

Although the example where the vehicle passes through the ITS spot while performing the vehicle-to-vehicle communication has been described here, a communication area of the first wireless communication device 1 may be any communication area covered by a roadside apparatus, such as a communication area based on an ETC gate, and is not limited to DSRC. Further, the communication of the second wireless communication device 2 is not limited to the vehicle-to-vehicle communication, and may be any V2X communication of a communication scheme different from that of the first wireless communication device 1, including a communication system such as a wireless LAN used in the vehicle, or a mobile phone using the same frequency band as the vehicle-to-infrastructure communication or a frequency band close to that of the vehicle-to-infrastructure communication.

In this way, the communication control device of the present embodiment restricts the transmission operation of the second wireless communication device when detecting that the first wireless communication device is performing communication. This makes it possible to prevent a length of time to perform transmission restriction on the second wireless communication device for avoiding interference between the communication of the first wireless communication device and the communication of the second wireless communication device, from becoming longer than necessary.

### Fourth Embodiment

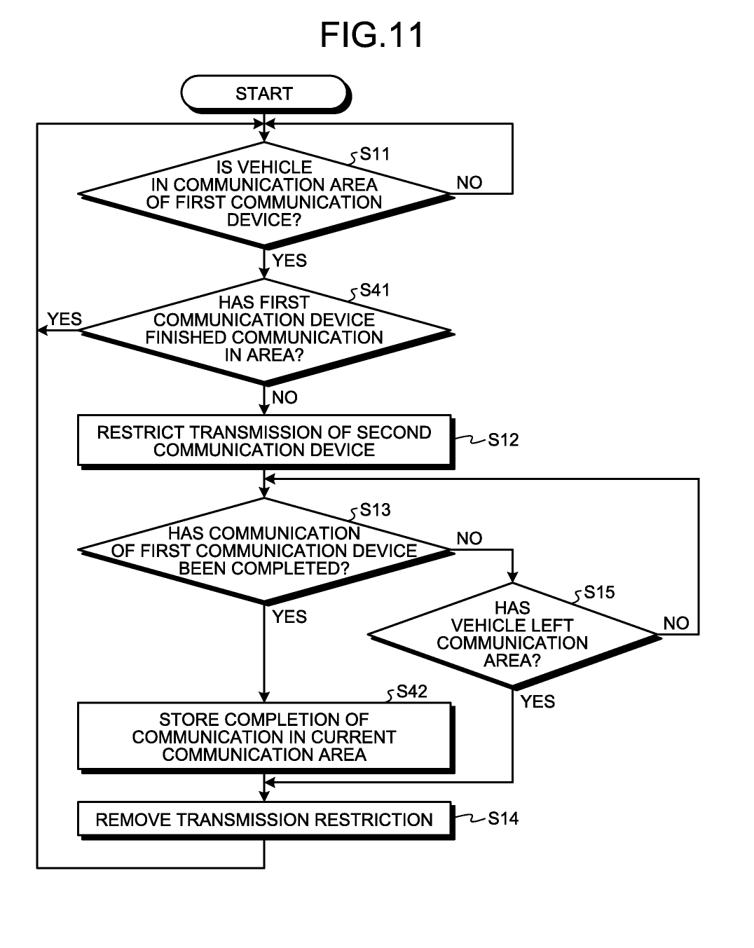

FIG. 11 is a flowchart illustrating an operation example of a communication control device according to the fourth embodiment. The configuration of the communication control device according to the fourth embodiment is similar to the configuration of the communication control device 3 according to the first embodiment illustrated in FIG. 2. The flowchart illustrated in FIG. 11 is obtained by adding steps S41 and S42 to the flowchart illustrating the operation example of the communication control device 3 according to the first embodiment illustrated in FIG. 3. More specifically, the step S41 is added between the steps S11 and S12 of the flowchart illustrated in FIG. 3, and the step S42 is added between the steps S13 and S14. In the present embodiment, the description of processing in steps other than the added steps S41 and S42 will be omitted.

When the communication control device 3 according to the fourth embodiment determines that the vehicle is in a communication area of the first wireless communication device 1 (step S11: Yes), the communication control device 3 determines whether or not the first wireless communication device 1 has finished communication, that is, whether or not the first wireless communication device 1 has completed communication in the current communication area of the first wireless communication device 1 in which the vehicle is present (step S41). In this step S41, the radio transmission control unit 33 checks information stored when a later-described step S42 has been executed in the past, and determines whether or not the first wireless communication device 1 has finished communication. When the first wireless communication device 1 has finished communication (step S41: Yes), the communication control device 3 returns to the step S11 and continues the operation. On the other hand, when the first wireless communication device 1 has not finished communication (step S41: No), the communication control device 3 executes the step S12 and processing subsequent thereto. When the communication control device 3 has executed steps S12 and S13 and detected that the communication of the first wireless communication device 1 has been completed (step S13: Yes), the communication control device 3 stores information/data on the fact that the communication of the first wireless communication device 1 in the current communication area has been completed (step S42). In this step S42, the radio transmission control unit 33 writes and stores information indicating that the communication of the first wireless communication device 1 has been finished, in a storage unit not illustrated in FIG. 2. The radio transmission control unit 33 stores information indicating that the communication of the first wireless communication device 1 has been finished and identification information of the communication area in association with each other, or at the point in time when the radio transmission control unit 33 detects that the vehicle has left the communication area, the radio transmission control unit 33 deletes the stored information, that is, the information indicating that the communication of the first wireless communication device 1 has been finished. After executing the step S42, the communication control device 3 executes the step S14.

As described above, the communication control device of the present embodiment restricts the transmission operation of the second wireless communication device when detecting that the vehicle is in a vehicle-to-infrastructure communication area that is an area in which the first wireless communication device performs vehicle-to-infrastructure communication that is communication with a higher priority, and removes the restriction on the transmission operation of the second wireless communication device when the communication of the first wireless communication device is completed. In addition, when the communication control device detects that the communication of the first wireless communication device has been completed, the communication control device stores information/data on the completion, and thereafter, does not restrict the transmission operation of the second wireless communication device in the same vehicle-to-infrastructure communication area. As in the first embodiment, this makes it possible to prevent the length of time to perform transmission restriction on the second wireless communication device for avoiding interference between the communication of the first wireless communication device and the communication of the second wireless communication device, from becoming longer than necessary. In addition, it is possible to prevent transmission restriction from being performed again in the same communication area.

In the present embodiment, the steps S41 and S42 described above are added to the operation of the communication control device 3 according to the first embodiment. Alternatively, the steps S41 and S42 may be added to the operation of the communication control device 3a according to the second embodiment.

### Fifth Embodiment

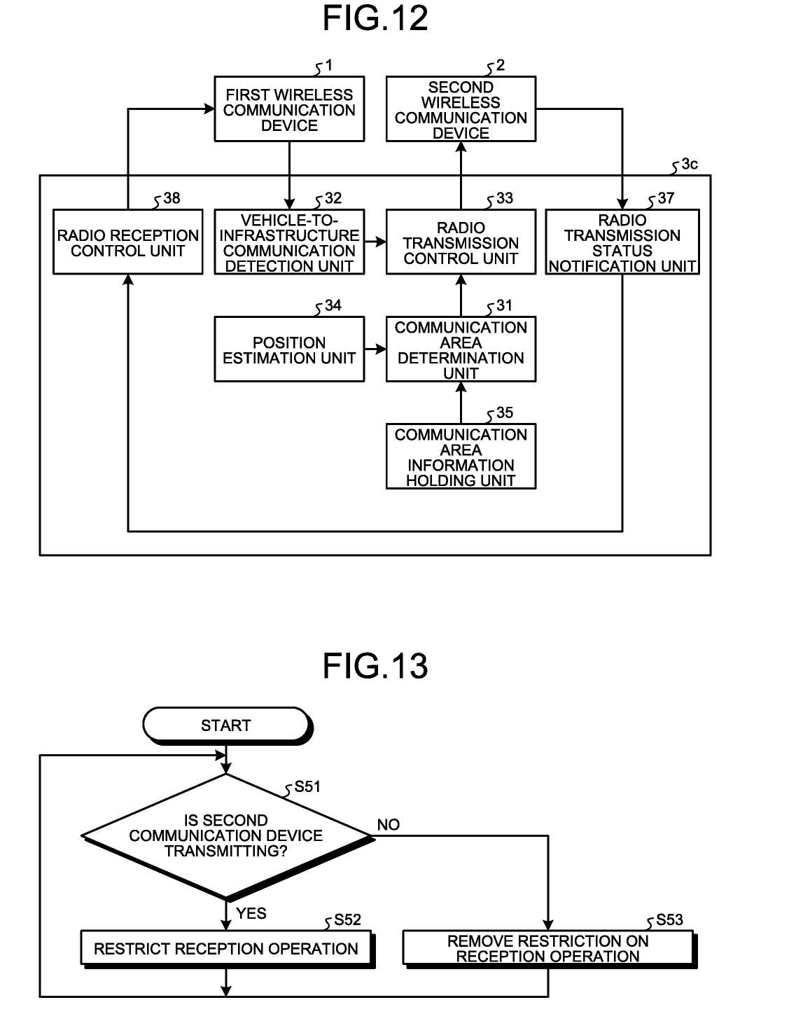

FIG. 12 is a diagram illustrating a configuration example of a communication control device according to the fifth embodiment. Note that a communication control device 3c according to the fifth embodiment is equipped in a vehicle together with the in-vehicle device 5 illustrated in FIG. 1, as with the communication control device according to the first embodiment.

The communication control device 3c has a configuration in which a radio transmission status notification unit 37 and a radio reception control unit 38 are added to the communication control device 3 according to the first embodiment illustrated in FIG. 2. The other constituent elements of the communication control device 3c are similar to those of the communication control device 3, and hence the same reference symbols are assigned to them and the description thereof will be omitted.

The radio transmission status notification unit 37 determines whether or not the second wireless communication device 2 is currently transmitting, and notifies the radio reception control unit 38 of the determination result. The radio transmission status notification unit 37 is a transmission status determination unit that determines the transmission status based on a signal outputted from the second wireless communication device 2 for notifying the transmission status. The signal for notifying the radio transmission status notification unit 37 of the transmission status from the second wireless communication device 2 is newly produced internally by the second wireless communication device 2, or as the signal, a signal that can fulfill a function thereof is selected from among existing signals used inside the second wireless communication device 2 and is used. For example, if there is an internal signal that changes in status between a state of performing radio transmission and a state of not performing radio transmission among signals in the second wireless communication device 2, then the second wireless communication device 2 outputs that internal signal.

The radio reception control unit 38 controls the reception operation of the first wireless communication device 1, based on notification contents from the radio transmission status notification unit 37. Specifically, when notification from the radio transmission status notification unit 37 indicates that the second wireless communication device 2 is currently in transmission by radio, the radio reception control unit 38 restricts the reception operation of the first wireless communication device 1.

FIG. 13 is a flowchart illustrating an operation example of the radio reception control unit 38 according to the fifth embodiment. The radio reception control unit 38 determines whether or not the second wireless communication device 2 is currently in transmission operation (step S51). When the second wireless communication device 2 is in transmission (step S51: Yes), the radio reception control unit 38 restricts the reception operation of the first wireless communication device 1 (step S52). When the second wireless communication device 2 is not in transmission operation (step S51: No), the radio reception control unit 38 removes the restriction on the reception operation of the first wireless communication device 1 (step S53). That is, when notification from the radio transmission status notification unit 37 indicates that the second wireless communication device 2 is transmitting, the radio reception control unit 38 instructs the first wireless communication device 1 not to perform the reception operation, and when notification from the radio transmission status notification unit 37 indicates that the second wireless communication device 2 is not transmitting, the radio reception control unit 38 instructs the first wireless communication device 1 to perform the reception operation.

The restriction on the reception operation to be performed on the first wireless communication device 1 by the radio reception control unit 38 is either suspension of the reception operation or switching to a reception operation on a channel that is not affected by transmission of the second wireless communication device 2. When the radio reception control unit 38 is configured to perform switching of a channel for the reception operation, the radio transmission status notification unit 37 notifies the radio reception control unit 38 of information on a channel used for transmission by the second wireless communication device 2.

It is noted that the description has been given for the case where the radio transmission status notification unit 37 and the radio reception control unit 38 are added to the communication control device of the first embodiment, but the radio transmission status notification unit 37 and the radio reception control unit 38 may be added to any of the communication control devices of the second to fourth embodiments.

As described above, when the second wireless communication device is in a transmitting operation, the communication control device in the present embodiment is adapted to additionally perform an operation of restricting the reception operation of the first wireless communication device in addition to the operations described in any one of the first to fourth embodiments. By so doing, not only the advantageous effects obtained by the communication control devices described in the first to fourth embodiments, but also another advantageous effect can be obtained in that the first wireless communication device can be prevented from uselessly performing the reception operation due to the diffracted waves of a signal in the vehicle, so as to ensure the obtainment of proper reception opportunities. Further, it is possible to suppress an increase in power consumption due to useless execution of the reception operation.

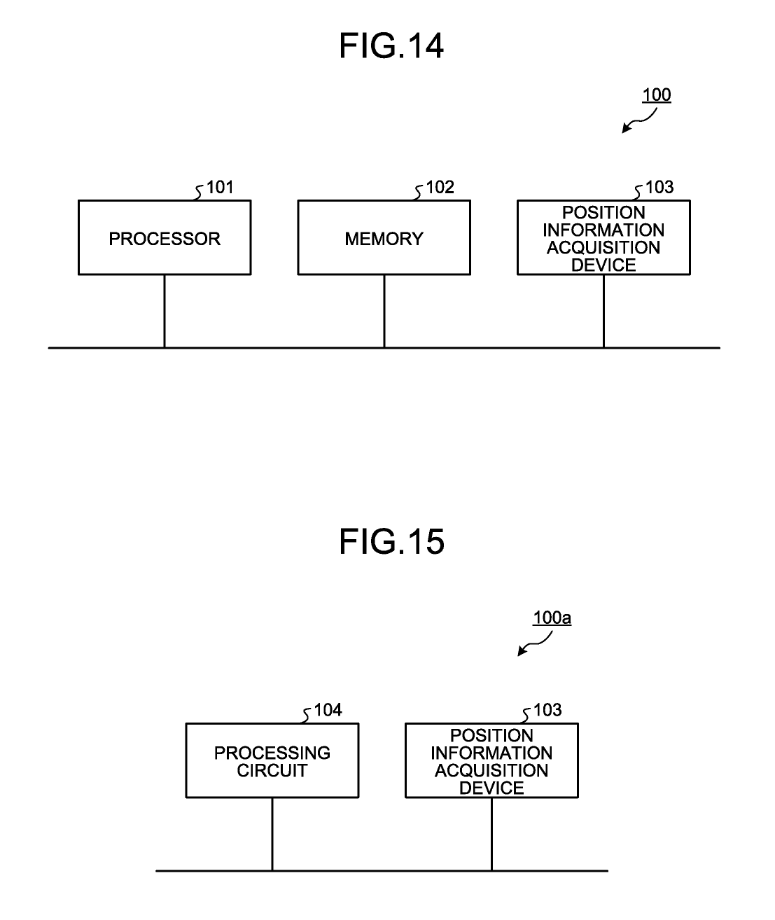

Hardware for realizing the communication control device described in the embodiments will be described. FIG. 14 is a hardware configuration diagram of the communication control devices according to the first to fifth embodiments.

The communication control devices described in the first to fifth embodiments can be realized by a control circuit 100 illustrated in FIG. 14. The control circuit 100 is configured to include a processor 101, a memory 102, and a position information acquisition device 103. The processor 101 is a Central Processing Unit (CPU, also called a central processor, a processing unit, an arithmetic unit, a microprocessor, a microcomputer, a processor, and a DSP), a system Large Scale Integration (LSI), or the like. The memory 102 is a nonvolatile or volatile semiconductor memory such as a Random Access Memory (RAM), a Read Only Memory (ROM), a flash memory, an Erasable Programmable Read Only Memory (EPROM), or an Electrically Erasable Programmable Read-Only Memory (EEPROM), or a magnetic disk, a flexible disk, an optical disk, a compact disk, a mini disk, a Digital Versatile Disc (DVD), or the like. The position information acquisition device 103 is a GPS receiver or the like.

The communication area determination unit 31, the vehicle-to-infrastructure communication detection unit 32, the radio transmission control unit 33, 33a, or 33b, the radio transmission status notification unit 37, and the radio reception control unit 38, which constitute the communication control device described in the first to fifth embodiments can be implemented by the processor 101 reading their respective corresponding programs from the memory 102 and executing the programs. The position estimation unit 34 can be realized by the position information acquisition device 103. The timer 36 can be realized by a timer function the processor 101 has.

Note that the communication area determination unit 31, the vehicle-to-infrastructure communication detection unit 32, the radio transmission control unit 33, 33a, or 33b, the radio transmission status notification unit 37, and the radio reception control unit 38 may be realized by dedicated hardware.

FIG. 15 is a hardware configuration diagram of the communication control devices according to the first to fifth embodiments when the communication area determination unit 31, the vehicle-to-infrastructure communication detection unit 32, the radio transmission control unit 33, 33a, or 33b, the timer 36, the radio transmission status notification unit 37, and the radio reception control unit 38 are realized by dedicated hardware. A control circuit 100a illustrated in FIG. 15 has a processing circuit 104 in place of the processor 101 and the memory 102 of the control circuit 100 illustrated in FIG. 14. The processing circuit 104 is a single circuit, a composite circuit, a programmed processor, a parallel-programmed processor, an Application Specific Integrated Circuit (ASIC), a Field Programmable Gate Array (FPGA), or a circuit or circuits formed by combining them. The processing circuit 104 conducts functions of the communication area determination unit 31, the vehicle-to-infrastructure communication detection unit 32, the radio transmission control units 33, 33a, and 33b, the timer 36, the radio transmission status notification unit 37, and the radio reception control unit 38. Some of the communication area determination unit 31, the vehicle-to-infrastructure communication detection unit 32, the radio transmission control units 33, 33a, and 33b, the timer 36, the radio transmission status notification unit 37, and the radio reception control unit 38 may be realized by the processing circuit 104, and the rest thereof may be realized by the processor 101 and the memory 102 illustrated in FIG. 14.

The configurations illustrated in the above embodiments illustrate examples of the subject matters of the present invention, and can be combined with other publicly known techniques and can be partly omitted and/or changed without departing from the scope of the present invention.

### REFERENCE SIGNS LIST

1 first wireless communication device; 2 second wireless communication device; 3, 3a, 3b, 3c communication control device; 4 in-vehicle communication apparatus; 5 in-vehicle device; 10 vehicle; 20 ETC gate; 21 ETC communication area; 22 branch area; 23 merging area; 24 roadside apparatus; 25 vehicle-to-infrastructure communication area; 31 communication area determination unit; 32 vehicle-to-infrastructure communication detection unit; 33, 33a, 33b radio transmission control unit; 34 position estimation unit; 35 communication area information holding unit; 36 timer; 37 radio transmission status notification unit; 38 radio reception control unit.

1-14. (canceled)

15. A communication control device in a vehicle having a first wireless communication device to perform vehicle-to-infrastructure communication in a predetermined place on a road and a second wireless communication device to perform communication using a frequency band that has a possibility to cause interference with communication of the first wireless communication device, which are equipped in the vehicle, to control the second wireless communication device, the communication control device comprising:
a communication state detection unit to detect a communication state of the first wireless communication device;
a radio transmission controller to control a transmission operation of the second wireless communication device based on a result of the detection obtained by the communication state detector;
a position estimator to estimate a position of the vehicle;
a communication area information holding circuit to hold information on an area in which the first wireless communication device performs the vehicle-to-infrastructure communication; and
a communication area determination circuit to determine whether or not the vehicle is present in a vehicle-to-infrastructure communication area that is an area in which the first wireless communication device performs the vehicle-to-infrastructure communication, based on a result of the estimation obtained by the position estimator and the information held by the communication area information holding circuit,
wherein when the radio transmission controller determines that the vehicle has entered the vehicle-to-infrastructure communication area based on a result of the determination obtained by the communication area determination circuit, the radio transmission controller restricts the transmission operation of the second wireless communication device so that the second wireless communication device performs transmission at a timing when the first wireless communication device does not perform communication during a period from when the first wireless communication device starts communication until when the first wireless communication device finishes the communication after executing a series of communication sequences, and when the radio transmission controller is notified by the communication state detector that the vehicle-to-infrastructure communication performed by the first wireless communication device has been completed, the radio transmission controller removes the restriction on the transmission operation of the second wireless communication device.

16. The communication control device according to claim 15, wherein the information on the area in which the first wireless communication device performs the vehicle-to-infrastructure communication, which is held by the communication area information holding circuit, is map information and position information of a radio roadside apparatus that performs communication with the first wireless communication device.

17. The communication control device according to claim 15, wherein the information on the area in which the first wireless communication device performs the vehicle-to-infrastructure communication, which is held by the communication area information holding circuit, is updated at regular intervals or at irregular intervals via the first wireless communication device or the second wireless communication device.

18. The communication control device according to claim 15, wherein when the radio transmission controller in a state of restricting the transmission operation of the second wireless communication device determines that the vehicle has left the vehicle-to-infrastructure communication area, based on a result of the determination obtained by the communication area determination circuit, the radio transmission controller removes the restriction on the transmission operation of the second wireless communication device.

19. The communication control device according to claim 15, further comprising: a counter to start counting when a result of the determination obtained by the communication area determination circuit indicates that the vehicle has entered the vehicle-to-infrastructure communication area, and to stop counting when a predetermined period of time has elapsed since starting the counting,
wherein when the counter stops the counting, the radio transmission controller in a state of restricting the transmission operation of the second wireless communication device removes the restriction on the transmission operation of the second wireless communication device.

20. The communication control device according to claim 18, wherein when the vehicle-to-infrastructure communication by the first wireless communication device is completed and the radio transmission controller removes the restriction on the transmission operation of the second wireless communication device, the radio transmission controller stores information representing the completion of the communication of the first wireless communication device, and does not perform restriction of the transmission operation on the second wireless communication device until the radio transmission control unit determines that the vehicle has entered a next vehicle-to-infrastructure communication area.

21. A communication control device in a vehicle having a first wireless communication device to perform vehicle-to-infrastructure communication in a predetermined place on a road and a second wireless communication device to perform communication using a frequency band that has a possibility to cause interference with communication of the first wireless communication device, which are equipped in the vehicle, to control the second wireless communication device, the communication control device comprising:
a communication state detector to detect a communication state of the first wireless communication device;
a radio transmission controller to control, based on a result of the detection obtained by the communication state detector, a transmission operation of the second wireless communication device so that the second wireless communication device performs transmission at a timing when the first wireless communication device does not perform communication during a period from when the first wireless communication device starts communication to when the first wireless communication device finishes the communication after executing a series of communication sequences;
a transmission status determination circuit to determine a transmission status of the second wireless communication device; and
a radio reception controller to control a reception operation of the first wireless communication device based on a result of the determination obtained by the transmission status determination circuit.

22. The communication control device according to claim 21, wherein the radio reception controller restricts the reception operation of the first wireless communication device in a state where the second wireless communication device is performing transmission.

23. The communication control device according to claim 15, wherein the vehicle-to-infrastructure communication performed by the first wireless communication device has a higher priority than the communication performed by the second wireless communication device.

24. The communication control device according to claim 15, wherein the vehicle-to-infrastructure communication performed by the first wireless communication device is narrowband communication.

25. The communication control device according to claim 21, wherein
the vehicle has two or more second wireless communication devices that are each equal to the second wireless communication device, which are equipped in the vehicle, and
the radio reception controller performs control on transmission operations of all the second wireless communication devices equipped in the vehicle.

26. The communication control device according to claim 15, wherein the first wireless communication device and the second wireless communication device are housed in a single housing.

27. The communication control device according to claim 19, wherein when the vehicle-to-infrastructure communication by the first wireless communication device is completed and the radio transmission controller removes the restriction on the transmission operation of the second wireless communication device, the radio transmission controller stores information representing the completion of the communication of the first wireless communication device, and does not perform restriction of the transmission operation on the second wireless communication device until the radio transmission controller determines that the vehicle has entered a next vehicle-to-infrastructure communication area.

28. The communication control device according to claim 21, wherein the vehicle-to-infrastructure communication performed by the first wireless communication device has a higher priority than the communication performed by the second wireless communication device.

29. The communication control device according to claim 21, wherein the vehicle-to-infrastructure communication performed by the first wireless communication device is narrowband communication.

30. The communication control device according to claim 21, wherein the first wireless communication device and the second wireless communication device are housed in a single housing.
